(19) United States
(12) Patent Application Publication
(10) Pub. No.: US 2005/0220559 A1
(43) Pub. Date: Oct. 6, 2005

(54) Container used to ship semi-trailer chassis

(76) Inventors: Shulin Yang, Shenzhen (CN); Sidong He, Shenzhen (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/095,550

(22) Filed: Apr. 1, 2005

(30) Foreign Application Priority Data
Apr. 6, 2004 (CN) 200420049821.6

(51) Int. Cl. B60P 3/06

(52) U.S. Cl. 410/56

(57) ABSTRACT

A container used for transportation of semi-trailer chassis, frame structure is adopted for the container mentioned, including: at least two pieces of bottom side beam; at least two pieces of bottom cross beam intersecting with bottom side beam; at least four pieces of vertical angle post intersecting with bottom side beam or bottom cross beam; bottom side beam, bottom cross beam and angle post are connected to form a rectangle frame structure. The container is specially used to ship semi-trailer chassis, it can load four stacked semi-trailer chassis, therefore realize containerized transportation of semi-trailer chassis, reaching the target of enhancing of efficiency of transportation of semi-trailer chassis and reduction of transportation cost of semi-trailer chassis.

### FIELD OF THE INVENTION

The present invention relates to the structure of the container, and relates more particularly to the container which is used for transportation of semi-trailer.

### BACKGROUND OF THE INVENTION

Semi-trailer is a widely-used transportation tool, of which the key part is its chassis, FIG. 1 illustrates a 40′ semi-trailer chassis 1, which consists of chassis girder 11, wheel 12 and tapered end 13.

At present, ocean shipment of semi-trailer chassis is through bulk cargo ship, of which the transportation cost is high, this directly affects production of semi-trailer chassis, and therefore, it is necessary to adopt an efficient and cheap transportation method.

Container is a standard international general-purpose transportation tool used in multiple modes through transportation, container can be piled up to enhance storage capacity of deck of a ship, so that transportation cost can be reduced, transportation efficiency can be enhanced, therefore container is used in numerous fields, especially transportation of special field products, and numerous types of special containers are researched, developed and designed.

Because width of 40′ semi-trailer chassis equals existing container, its length is longer than existing container, the existing container can not be used for transportation of 40′ semi-trailer chassis, therefore, it is necessary to research and develop a special container for transportation of 40′ semi-trailer chassis.

### SUMMARY OF THE INVENTION

The purpose of this invention is to provide a special container for transportation of semi-trailer chassis, enhance efficiency of chassis transportation and reduce cost of chassis transportation.

To realize the above mentioned purpose, the technical solution of the invention is indicated as follows:

A kind of container used for transportation of semi-trailer chassis, frame structure is adopted for the container mentioned, including: at least two pieces of bottom side beam; at least two pieces of bottom cross beam intersecting with bottom side beam therefore forming bottom of frame; at least four pieces of vertical angle posts intersecting with frame bottom, i.e. bottom side beam or/and bottom cross beam, therefore forming a rectangle frame structure; described bottom side beam, bottom cross beam and angle post are connected to form a rectangle frame structure.

Regarding the described container which is used for transportation of semi-trailer chassis, in which, the described bottom cross beam is fixed and positioned on middle section of bottom side beam described.

Regarding the described container used for transportation of semi-trailer chassis, in which, the described container also includes the other two pieces of bottom cross beam fixed and positioned on end section of bottom side beam.

Regarding the described container used for transportation of semi-trailer chassis, in which, the described bottom cross beam is fixed and positioned on end of bottom side beam described.

Regarding the described container used for transportation of semi-trailer chassis, in which, standard size of ISO 20′ or ISO 40′ container are adopted for frame space formed by described angle post.

Regarding the described container used for transportation of semi-trailer chassis, in which, standard size of ISO 40′ container is adopted for bottom of frame formed by described bottom side beam and bottom cross beam.

Regarding the described container used for transportation of semi-trailer chassis, in which, folding structure is adopted for folding of described angle post toward the bottom of the described container.

Regarding the described container used for transportation of semi-trailer chassis, in which, the described bottom side beam includes at least two pieces of section material, top surface of one section material is lower than top surface of the other section material and forms drop height.

Regarding the described container used for transportation of semi-trailer chassis, in which, top surface of the two pieces of section material described is configured as slope comparing with horizontal surface.

Regarding the described container used for transportation of semi-trailer chassis, in which, two pieces of section material are connected together through intermediate section material, top surface of the intermediate section material is configured as slope comparing with horizontal surface.

Regarding the described container used for transportation of semi-trailer chassis, in which, there is positioning part with hole on frame structure, on top of it, there is vertical location hole corresponding to shape of tapered end on semi-trailer chassis.

Regarding the described container used for transportation of semi-trailer chassis, in which, there is positioning part with hole on end of one piece of section material with higher top surface of bottom side beam, top surface of the positioning part is configured as slope comparing with horizontal surface, on top of it, there is vertical location hole corresponding to shape of tapered end on semi-trailer chassis.

Regarding the described container used for transportation of semi-trailer chassis, in which, there is reinforcing cross beam installed between two pieces of bottom side beam.

Regarding the described container used for transportation of semi-trailer chassis, in which, there is reinforcing rib between the described angle post and bottom side beam or bottom cross beam, and between bottom side beam and bottom cross beam.

Regarding the described container used for transportation of semi-trailer chassis, in which, welding is adopted for forming of container frame structure

Due to adoption of above mentioned technical solution and adoption of frame structure for container, loading of chassis is realized; to solve the problem that length of chassis is larger than length of container, open-up structure is adopted; regarding transportation of container, for the convenience of hoist or stacking and etc, specification size of 20′ is used on the top, and specification size of 40′ is used on bottom, specification size of 20′ is used on bottom middle angle part, this container can be stacked on common 40′ container for transportation, and on top of it, 20′ common container can be stacked; regarding cargo positioning, by inserting tapered end of chassis into positioning hole on container, and form height drop on bottom of container, as stacked goods, numerous chassis will be tilted for certain degree, ensuring that height is within allowable range; therefore, realized containerized transportation of semi-trailer chassis and achieved the effect of enhancing of transportation efficiency and reduction of chassis transportation cost.

### BRIEF DESCRIPTION OF THE DRAWINGS

Combined with drawings attached as follows, through detailed description of specific implementation approach of this invention, it will be clear and easy to see technical solution and other beneficial effects of this invention.

In attached drawing,

FIG. 1 is a front view of existing 40′ semi-trailer chassis.

FIG. 1A is a front view of four existing 40′ semi-trailer chassis stacked together.

FIG. 1B is an enlarged drawing of section A of FIG. 1A;

FIG. 2 is a front view of four semi-trailer chassis stacked together in the invention of container.

FIG. 3A is spatial structure sketch of the first preferred embodiment of container used for transportation of semi-trailer chassis described in this invention;

FIG. 3B is an enlarged drawing of section B of FIG. 3;

FIG. 3C is an enlarged drawing of section C of FIG. 3;

FIG. 4 is spatial structure sketch of the second preferred embodiment of container used for transportation of semi-trailer chassis described in this invention;

FIG. 5 is spatial structure sketch of the third preferred embodiment of container used for transportation of semi-trailer chassis described in this invention;

FIG. 6 is spatial structure sketch of the fourth preferred embodiment of container used for transportation of semi-trailer chassis described in this invention;

### DESCRIPTION OF THE PREFERRED EMBODIMENTS

To further describe technical solution and function adopted by this invention to realize expected target, please see the following relevant detailed illustration and drawing attached regarding this invention, it is believed that purpose, characteristics and features of this invention will be further understood in details through this, but the attached drawing and implementation method is provided only for reference and illustration, they are not supposed to restrict this new invention.

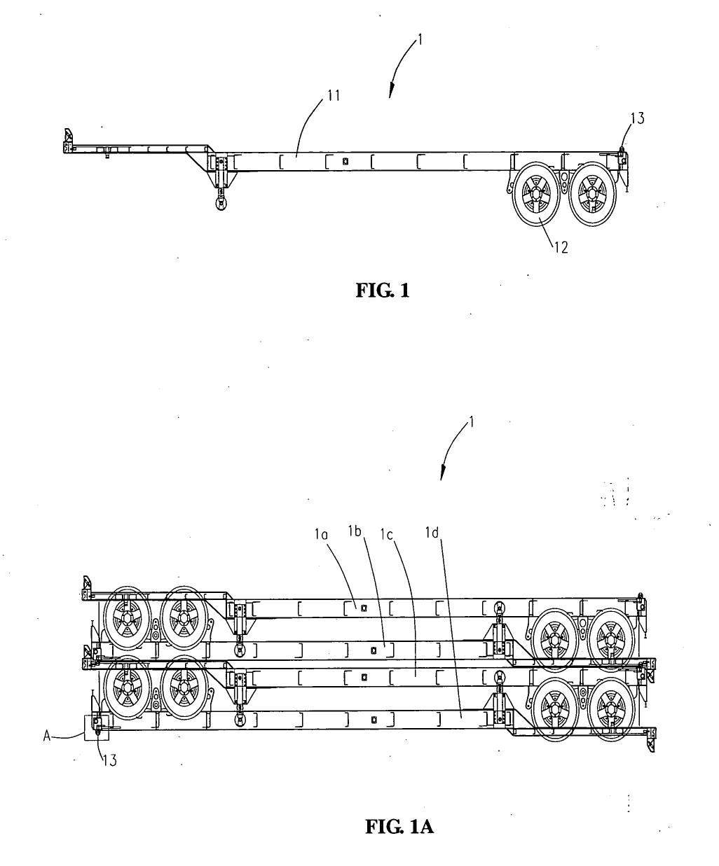

For convenience of transportation, four semi-trailer chassis can be stacked as illustrated in FIG. 1A, the four chassis can be stacked in approach of “1a to be laid upside up-1b to be turned by 180 degree horizontally and laid upside down-1c to be laid upside up-1d to be turned by 180 degree horizontally and laid upside down”, reasonably use space and stack in approach which can best save space. FIG. 1B is enlarged drawing of section A of FIG. 1A, which clearly demonstrated tapered end 13 on the lowest chassis 1d.

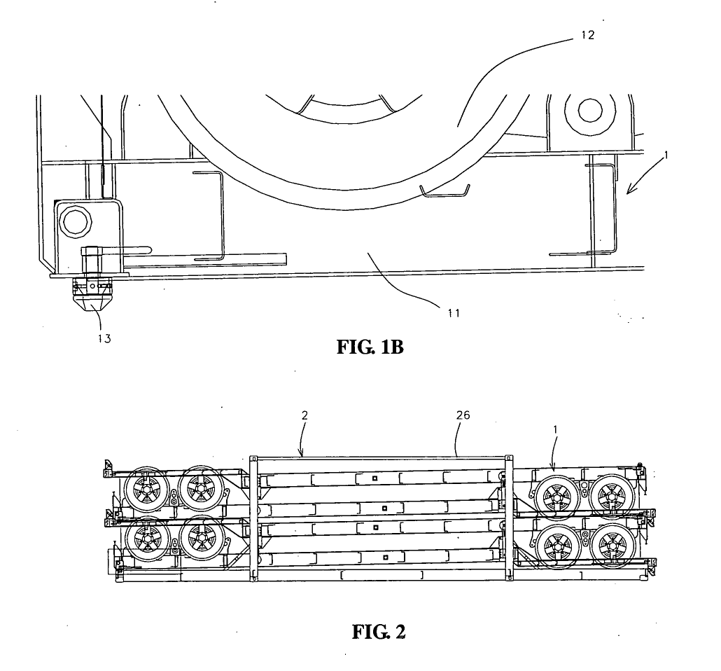

Referring to FIG. 2, each container 2 can transport four semi-trailer chassis 1 which are stacked together.

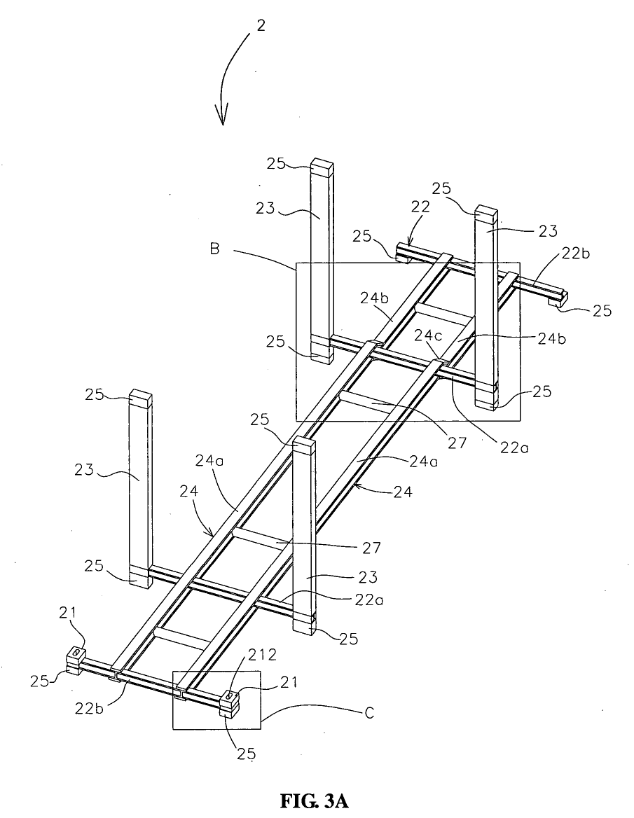

Referring to FIG. 3A to 3C, which show the first type of ideal implementation method of container 2 described in this invention. Frame structure is adopted for container 2, which consists of angle post 23, bottom side beam 24 and bottom cross beam 22. According to demand, top side beam 26 can be configured (as illustrated in FIG. 2).

Two pieces of bottom side beam 24 and four pieces of bottom cross beam 22 are vertically connected as bottom of a rigid frame body, both ends of two pieces of bottom cross beam 22a which lie in middle section are connected with vertical angle post 23, and form a frame structure, bottom cross beam 22b which lies on end of bottom side beam 24 acts as doorsill.

Angle post 23 can be fixed directly on bottom cross beam 22a, top side beam 26 can be fixed between two top angle parts 25 of angle post 23, in FIG. 2, design with top side beam is adopted; angle post 23 can also be designed as folding structure, which can be turned to bottom of container and therefore realize folding, here, top side beam should not be configured between top angle part 25 of angle post 23, in FIG. 3, design without top beam is adopted, angle post 23 can be folded, so that volume of empty container will be reduced for transportation, and shipping cost of empty container and storage space for itself will be reduced.

Standard size of ISO 20′ can be adopted for spacing of standard angle part 25 fixed on top of angle post 23; ISO 40′ standard size is adopted for spacing of two standard angle part 25 which are fixed on bottom ends of bottom cross beam 22b lying on two ends, and ISO 20′ standard can be adopted for spacing of two standard angle parts fixed on bottom of two middle bottom cross beam 22a.

This container can be stacked on common 40′ for shipment and common 20′ container cab be stacked on it to reduce transportation cost.

Two-segments structure is adopted for each piece of bottom side beam 24, it is formed by section material 24a, 24b and 24c fixed together, top surface of section material 24a is configured as slope comparing with horizontal surface, with outside being higher than inside, where top surface of section material 24b is parallel and lower than top surface of section material 24a and forms drop height, as illustrated in FIG. 3 and FIG. 3A, section material 24c is a transition part for section material 24a and 24b which are connected as a whole, top surface of 24c forms slope comparing with horizontal surface.

There is reinforcing cross beam 27 fixed between two pieces of bottom side beam 24.

There is positioning part 21 with hole fixed above both ends of bottom cross beam 22b of external end of a segment of section material which is fixed high above top surface of bottom side beam 24, on top of positioning part 21 with hole, there is vertical location hole 212 corresponding to tapered end 13 of semi-trailer chassis. In case chassis 1 is loaded into container, the lowest tapered end 13 of chassis is inserted into location hole 212 of positioning part 21 with hole. Top surface 211 of positioning part 21 with hole is parallel with top surface of section material 24b and section material 24a of bottom side beam 24, i.e. configured with slope comparing with horizontal surface, FIG. 2 illustrates high left and low right, so that four chassis which are piled together as good tilt a certain angle, so that height of four chassis will be reduced, FIG. 2 illustrates height limit of container meet requirements of standard, therefore realize containerized transportation of semi-trailer chassis,

There are reinforcing cross beams welded between angle post 23 and bottom side beam 24 or bottom cross beam 22, and between bottom side beam 24 and bottom cross beam 22 (this is not illustrated in drawing).

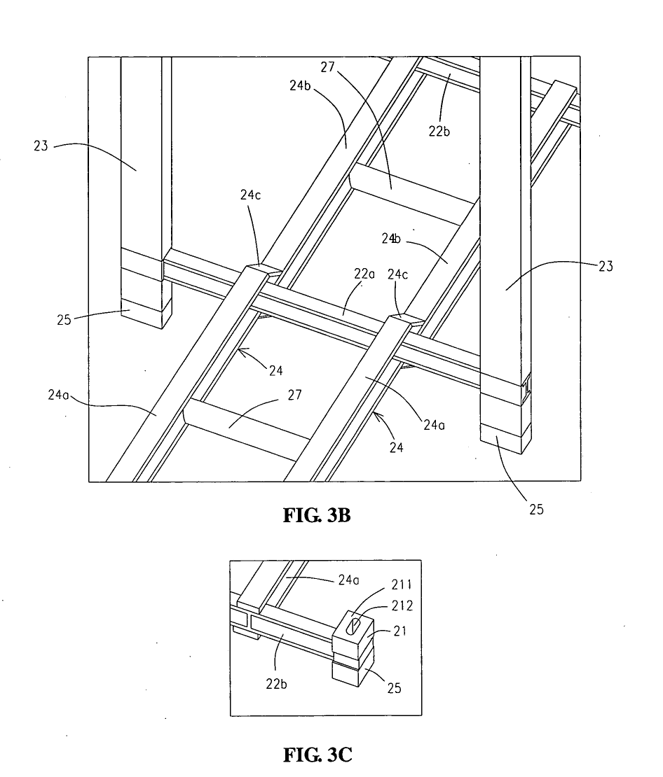

Referring to FIG. 4, which is the second preferred embodiment of this invention. Similar with the first preferred embodiment, frame structure is adopted for container 2, which consists of angle post 23 and bottom side beam 24 or bottom cross beam 22. The difference lie in that two pieces of bottom cross beam 22 are connected with end of two pieces of bottom side beam 24, and four pieces of angle post 23 are respectively fixed on end of two pieces of bottom cross beam 22, forming a frame structure.

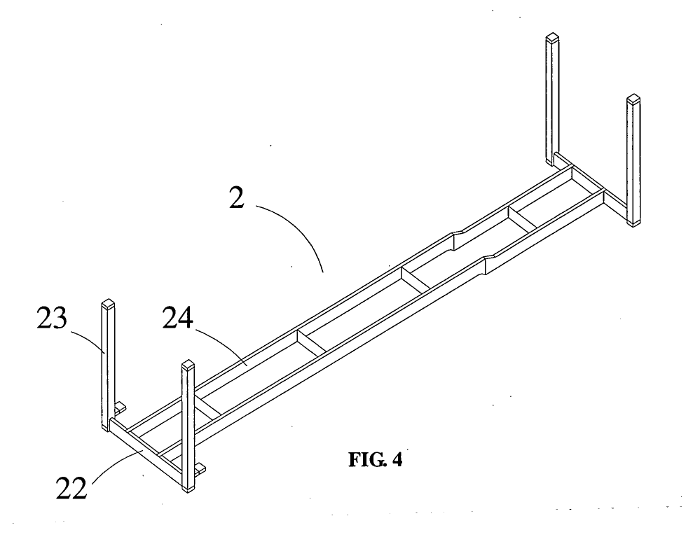

Referring to FIG. 5, which is the third preferred embodiment of this invention. The ends of two pieces of bottom cross beam 22 are connected with the ends of two pieces of bottom side beam 24, and four pieces of angle post 23 are respectively fixed on the place where bottom cross beams 22 are connected with bottom side beams 24, forming a frame structure.

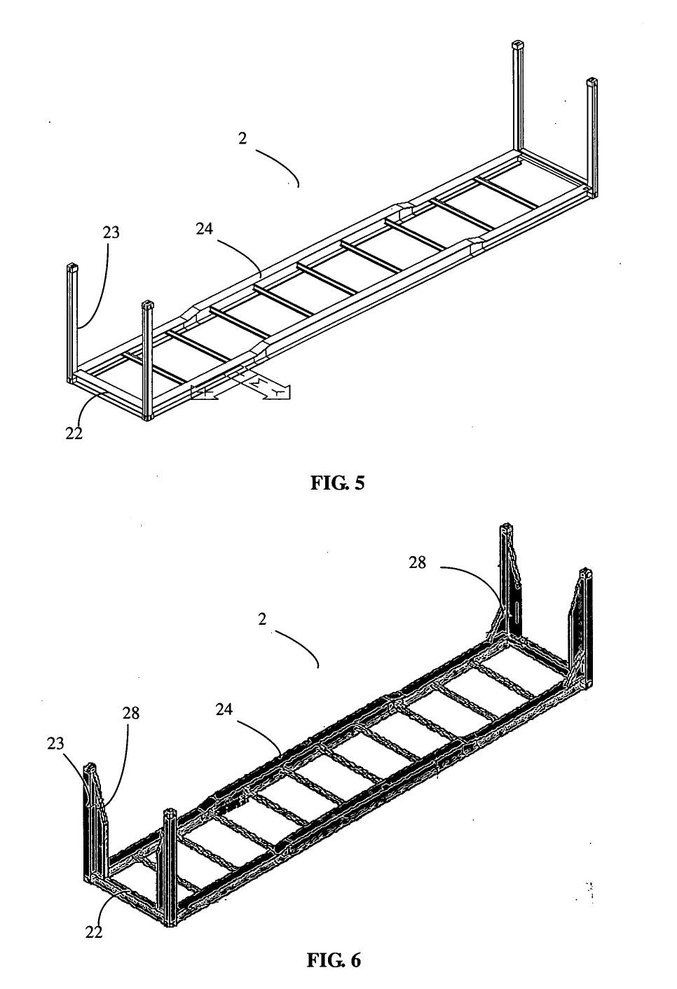

Referring to FIG. 6, which is the fourth preferred embodiment of this invention. It is similar with the third preferred embodiment. Furthermore, there is reinforcing rib 28 between the angle post and bottom side beam 24 or bottom cross beam 22.

The so called “fastening” above mentioned refers to connection methods meeting requirements of structure strength described, including weld connection, bolt connection, rivet connection brute force adherence and etc.

According to common sense of technology, the invention can be realized through other implement solutions without deviation with its essence or necessary characteristics. Therefore, the above mentioned implementation solutions published are only illustration by examples in terms of all respects, they are not the only one. All changes within the range of this invention or within the range equals to this invention will be covered by this invention.

1. A container used for transportation of semi-trailer chassis, its characteristics lie in frame structure is adopted for the container mentioned, including at least two pieces of bottom side beam, at least two pieces of bottom cross beam intersecting with bottom side beam to form bottom of a frame, at least four pieces of vertical angle post intersecting vertically with bottom side beam or/and bottom cross beam to form square shape structure, described bottom side beam, bottom cross beam and angle post being connected to form a rectangle frame structure.

2. The container used for transportation of semi-trailer chassis as claimed in claim 1, its characteristics is that described bottom cross beam is fixed on the middle section of bottom side beam.

3. The container used for transportation of semi-trailer chassis as claimed in claim 2, its characteristics is that the described container also include another two bottom cross beams fixed on end of bottom side beam.

4. The container used for transportation of semi-trailer chassis as claimed in claim 1, its characteristics is that described bottom cross beam is fixed on end of bottom side beam.

5. The container used for transportation of semi-trailer chassis as claimed in claim 1, its characteristics is that standard size of ISO 20′ or ISO 40′ container are adopted for frame space formed by described angle post.

6. The container used for transportation of semi-trailer chassis as claimed in claim 1, its characteristics is that standard size of ISO 40′ container is adopted for bottom of frame formed by described bottom side beam and bottom cross beam.

7. The container used for transportation of semi-trailer chassis as claimed in claim 1, its characteristics is that folding structure is adopted for folding of described angle post toward the bottom of the described container.

8. The container used for transportation of semi-trailer chassis as claimed in claim 1, its characteristics is that the described bottom side beam includes at least two pieces of section material, top surface of one section material is lower than top surface of the other section material and forms drop height.

9. The container used for transportation of semi-trailer chassis as claimed in claim 1, its characteristics is that top surface of the two pieces of section material described is configured as slope comparing with horizontal surface.

10. The container used for transportation of semi-trailer chassis as claimed in claim 8, its characteristics is that two pieces of section material are connected together through intermediate section material, top surface of the intermediate section material is configured as slope comparing with horizontal surface.

11. The container used for transportation of semi-trailer chassis as claimed in claim 1, its characteristics is that there is positioning part with hole on frame structure, on top of it, there is vertical location hole corresponding to shape of tapered end on semi-trailer chassis.

12. The container used for transportation of semi-trailer chassis as claimed in claim 8, its characteristics is that there is positioning part with hole on end of one piece of section material with higher top surface of bottom side beam, top surface of the positioning part is configured as slope comparing with horizontal surface, on top of it, there is vertical location hole corresponding to shape of tapered end on semi-trailer chassis.

13. The container used for transportation of semi-trailer chassis as claimed in claim 1, its characteristics is that there is reinforcing cross beam installed between two pieces of bottom side beam.

14. The container used for transportation of semi-trailer chassis as claimed in claim 1, its characteristics is that there is reinforcing rib between the described angle post and bottom side beam or bottom cross beam, and between bottom side beam and bottom cross beam.

15. The container used for transportation of semi-trailer chassis as claimed in claim 1, its characteristics is that welding is adopted for forming of container frame structure.
